(19) United States
(12) Patent Application Publication
(10) Pub. No.: US 2024/0112104 A1
(43) Pub. Date: Apr. 4, 2024

(54) INFORMATION PROCESSING APPARATUS, INFORMATION PROCESSING METHOD AND STORAGE MEDIUM

(71) Applicant: HONDA MOTOR CO., LTD., Tokyo (JP)

(72) Inventors: Kazuma TAMAKI, Wako-shi (JP); Yuji YASUI, Wako-shi (JP); Tokitomo ARIYOSHI, Wako-shi (JP); Ken IINUMA, Wako-shi (JP); Hideki MATSUNAGA, Wako-shi (JP)

(73) Assignee: HONDA MOTOR CO., LTD., Tokyo (JP)

(21) Appl. No.: 18/372,752

(22) Filed: Sep. 26, 2023

(30) Foreign Application Priority Data
Sep. 30, 2022 (JP) 2022-158653

(51) Int. Cl. G06Q 10/0631; G06Q 50/02

(52) U.S. Cl. CPC G06Q 10/063114; G06Q 50/02

(57) ABSTRACT

An information processing apparatus comprising: an acquisition unit configured to acquire physical strength information related to physical strength and time information related to a scheduled farm work time of a work group including at least one worker who performs farm work; a determination unit configured to determine a work ability of the work group based on the physical strength information; and a crop type selection unit configured to select a crop type to be proposed to the work group based on the work ability determined by the determination unit and the time information acquired by the acquisition unit.

### CROSS-REFERENCE TO RELATED APPLICATION(S)

This application claims priority to and the benefit of Japanese Patent Application No. 2022-158653, filed Sep. 30, 2022, the entire disclosure of which is incorporated herein by reference.

### BACKGROUND OF THE INVENTION

### Field of the Invention

The present invention relates to a technique of proposing a crop type to be cultivated for a work group that performs farm work.

### Description of the Related Art

Regarding the cultivation of a predetermined agricultural product, there is a farm management guidance support device that presents a piece of advice according to the years of experience and characteristics of a farm producer among predetermined pieces of advice to the farm producer based on the situation of the farmland (Japanese Patent No. 6341548).

On the other hand, the farm management guidance support device of Japanese Patent No. 6341548 assumes a person who already cultivates a specific agricultural product and manages a farm as a user, and does not assume a person who has not yet cultivated an agricultural product, such as a person who intends to newly manage a farm or a person who intends to own a home garden. Therefore, in the farm management guidance support device described in Japanese Patent No. 6341548, it has been difficult to increase the number of new farm producers and lead to favorable food supply and demand.

### SUMMARY OF THE INVENTION

An object of the present invention is to propose, to a work group performing farm work, a crop type suitable for cultivation according to a characteristic of a worker of the work group, and to support sustainable agriculture.

The present invention in its first aspect provides an information processing apparatus comprising: an acquisition unit configured to acquire physical strength information related to physical strength and time information related to a scheduled farm work time of a work group including at least one worker who performs farm work; a determination unit configured to determine a work ability of the work group based on the physical strength information; and a crop type selection unit configured to select a crop type to be proposed to the work group based on the work ability determined by the determination unit and the time information acquired by the acquisition unit.

The present invention in its second aspect provides an information processing method comprising: acquiring physical strength information related to physical strength and time information related to a scheduled farm work time of a work group including at least one worker who performs farm work; determining a work ability of the work group based on the physical strength information; and selecting a crop type to be proposed to the work group based on the determined work ability and the acquired time information.

The present invention in its third aspect provides a non-transitory computer-readable storage medium storing therein a program for causing a computer to execute: an acquisition process of acquiring physical strength information related to physical strength and time information related to a scheduled farm work time of a work group including at least one worker who performs farm work; a determination process of determining a work ability of the work group based on the physical strength information; and a crop type selection process of selecting a crop type to be proposed to the work group based on the work ability determined in the determination process and the time information acquired in the acquisition process.

### BRIEF DESCRIPTION OF THE DRAWINGS

FIG. 1A is a schematic diagram of the proposal systems of the first and second embodiments and the first and second modifications, and FIG. 1B is a schematic diagram of the proposal systems of the third and fourth modifications;

FIG. 2 is a block diagram illustrating a configuration of a proposal server 100;

FIG. 3A is a diagram illustrating basic physical strength information managed by a basic physical strength DB 110 and FIG. 3B is a diagram illustrating efficiency information managed by an efficiency DB 120;

FIG. 4A is a diagram illustrating crop type information managed by the crop type DB 130 of the first embodiment, and FIG. 4B is a diagram illustrating crop type information managed by the crop type DB 130 of the second embodiment and the first to fourth modifications;

FIG. 5 is a block diagram illustrating a configuration of a communication terminal 200;

FIG. 6 is a flowchart illustrating proposal processing executed by the proposal server 100 of the first embodiment;

FIG. 7 is a flowchart illustrating proposal processing executed by the proposal server 100 of the second embodiment; and

FIG. 8 is a flowchart illustrating proposal processing executed by the proposal server 100 of a fourth modification.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

An embodiment to be described below will describe an example in which the present invention is applied to a proposal server that selects and presents, as a candidate, an appropriate crop type according to information regarding a user who wishes a proposal of a crop type to be cultivated, as an example of an information processing apparatus. However, the present invention is applicable to any device capable of selecting a crop type to be proposed for a work group that performs farm work.

In addition, in the present specification, the “crop type” will be described as indicating one variety of a specific crop (for example, the Baron potato in the case of potatoes). However, the crops handled as the proposal candidate in the proposal system do not need to limit the varieties, and may indicate a classification (for example, simply potato) of crops including a plurality of kinds of varieties. In addition, the “cultivation (of the crop type)” will be described as indicating a series of processes necessary until the harvest of the crop type. The cultivation may include not only a step of planting seeds and saplings of the crop type and a step of performing various kinds of care up to the subsequent harvest, but also a step of adjusting the soil of the farmland before planting or after harvesting.

<<Configuration of Proposal System>>

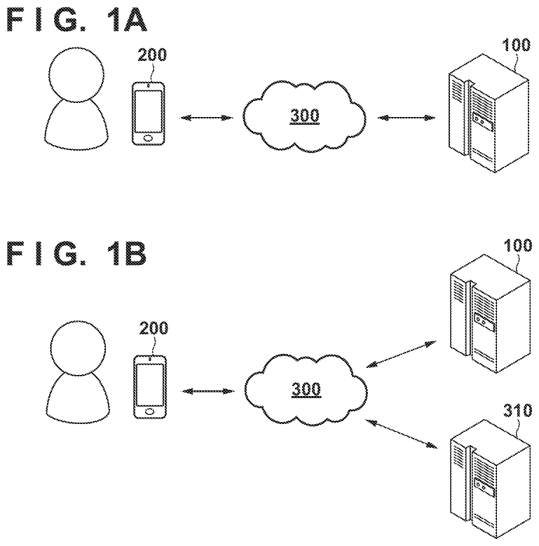

FIG. 1A is a diagram illustrating a configuration of a proposal system that provides a proposal service according to the present embodiment. As illustrated in the figure, the proposal system includes a communication terminal 200 used by a user, a proposal server 100 that receives information regarding a work group input in the communication terminal 200 and returns information regarding a crop type to be proposed to the work group, and a network 300 that communicably connects these devices.

In the present embodiment, a description will be given on the assumption that the user of the communication terminal 200 who desires the proposal of a crop type to be cultivated is one worker belonging to a work group including workers who actually perform farm work. However, it is needless to say that the user does not need to be a worker, and may be, for example, a person who is not involved in farm work but manages a work group, or a person in charge of a consultation desk for work groups or workers wishing to be newly engaged in agriculture in an agricultural cooperative or the like.

In addition, the work group may include a plurality of workers due to the characteristics of agriculture, but includes, for example, a work group including only one worker such as a home garden. That is, the scale of the work group is not limited as long as the work group includes at least one worker. Therefore, in order to facilitate understanding of the invention, an aspect in which the user who is the worker uses the proposal system for the work group to which only one worker belongs will be described below. Therefore, hereinafter, the work group may be simply referred to as a worker.

Note that the communication terminal 200 may be a general-purpose device having an information communication function, such as a PC or a smartphone. In addition, the network 300 will be described as a wide area network such as the Internet in order to realize communication connection between the communication terminal 200 and the proposal server 100 in the proposal system of the present embodiment. However, in an aspect in which a service is provided at a limited location such as an event venue for new agricultural entrants, for example, the network 300 may be a LAN.

Hereinafter, a hardware configuration involved in implementation of the information processing method according to the present invention will be further described with reference to the drawings.

<Hardware Configuration of Proposal Server 100>

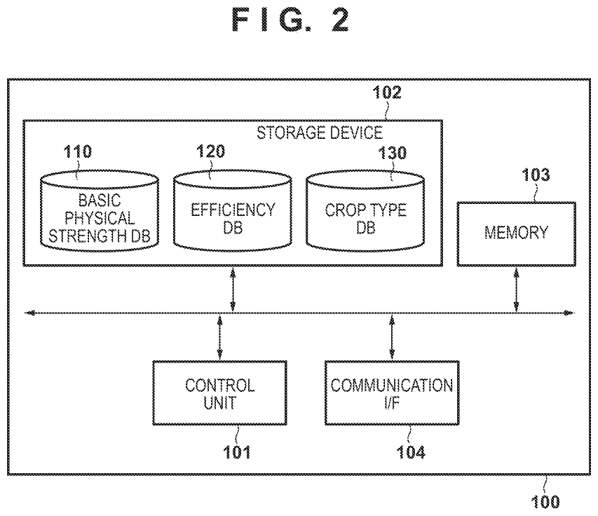

First, a hardware configuration of the proposal server 100 of the present embodiment will be described with reference to a block diagram of FIG. 2. A control unit 101 is a processor represented by a CPU, and implements operation control of each block and various functions to be described later by developing a program recorded in a storage device 102 in a memory 103 and executing the program. The storage device 102 is a nonvolatile storage device capable of permanently storing information, such as a ROM or an HDD. Here, the program executed by the control unit 101 may be installed in the storage device 102 of the proposal server 100 via a storage medium such as a CD-ROM. The memory 103 is a volatile storage device such as a RAM, and is used not only as a development area of a program or a work area of a function but also as a storage area in which information output by the operation of each block is temporarily recorded. A communication I/F 104 is an interface for performing information communication with an external device, and in the present embodiment, performs information communication with each communication terminal 200 via the network 300.

In addition to the program executed by the control unit 101, the storage device 102 includes a basic physical strength DB 110 that manages information (basic physical strength information) related to an index of basic physical strength for each age group of workers, an efficiency DB 120 that manages information (efficiency information) related to an index of work ability for each work level into which a work group is classified, and a crop type DB 130 that manages information (crop type information) related to each crop type.

<Basic Physical Strength Information>

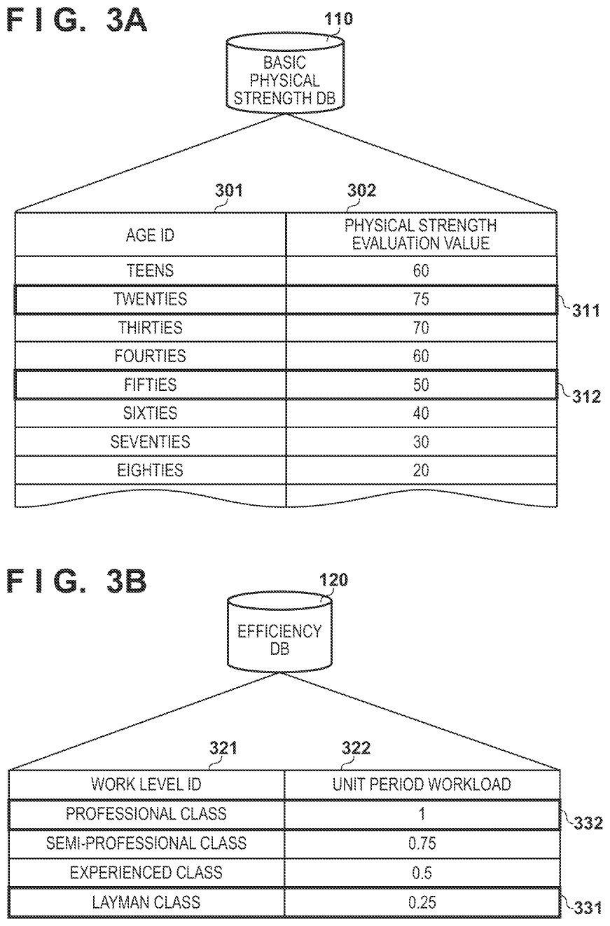

The basic physical strength information managed for each age group in the basic physical strength DB 110 is configured such that each record includes an age group ID 301 and a physical strength evaluation value 302, for example, as illustrated in FIG. 3A.

Here, the age group ID 301 is identification information that uniquely specifies the age group (age group) of the worker who performs the farm work. In addition, the physical strength evaluation value 302 is information indicating a predetermined degree of physical strength for workers in the age group specified by the age group ID 301. In the present embodiment, the physical strength evaluation value 302 may be determined based on, for example, a physical strength/exercise ability survey report or the like announced by the Sports Agency. More specifically, the physical strength evaluation value is derived by executing a predetermined arithmetic expression using the average value of each item included in the physical strength measurement result of the survey report, and can be used as an index of the basic physical strength in each age group. Here, the item referred to in the predetermined arithmetic expression can also be limited to an item such as a competition involving an operation related to farm work.

Therefore, for example, it can be seen that the physical strength evaluation value of the worker in his/her twenties is 75 from the physical strength evaluation value 302 of the record 311 in which the age group ID 301 indicates the age group twenties in FIG. 3A. In addition, for example, it can be seen that the physical strength evaluation value of the worker in his/her fifties is 50 from the physical strength evaluation value 302 of the record 312 in which the age group ID 301 indicates the age group fifties.

<Efficiency Information>

For example, as illustrated in FIG. 3B, the efficiency information managed for each work level in the efficiency DB 120 is configured such that each record includes a work level ID 321 and a unit period workload 322.

Here, the work level ID 321 is identification information for uniquely specifying the work level. Although details will be described later, in the proposal system of the present embodiment, the work ability of the worker is classified into a predetermined work level based on the physical strength evaluation value of the worker and evaluated. In the present embodiment, the work level is provided in four classes of “professional class”, “semi-professional class”, “experienced class”, and “layman class” (the earlier the work level is listed, the higher the physical strength evaluation value and the higher the class). Therefore, the work level ID 321 uniquely specifies any of these classes. Note that the name of each work level is not an evaluation of the actual production capacity regarding farming of the worker, but is provided as an index indicating the level of physical strength in terms of physical strength of the worker who performs farm work.

The unit period workload 322 is information indicating a workload per unit period determined in advance for the worker at the work level specified by the work level ID 321. In the proposal system of the present embodiment, for the worker whose physical strength evaluation value is classified into each work level, the workload per unit period that can be expected when actually performing the farm work is quantified and managed in advance as the unit period workload 322. In the quantification of the farm work that can be performed by the worker at each work level, it is assumed that the farm work is derived in advance by performing predetermined conversion calculation using a record obtained by getting a person having the physical strength evaluation value classified into the work level to perform endurance running, a race walk, or the like or a published physical strength measurement result. In the present embodiment, the unit period workload 322 is determined as a workload per hour of a worker at each work level in such a manner as to be assigned to a scale in which an average workload per hour of one agricultural worker belonging to an experienced full-time farmer is 1.

Therefore, for example, it can be seen that the workload per hour of the worker at the work level “layman class” is 0.25 from the unit period workload 322 of the record 331 in which the work level ID 321 indicates the layman class in FIG. 3B. In addition, for example, it can be seen that the workload per hour of the worker of the work level “professional class” is 1 from the unit period workload 322 of the record 332 in which the work level ID 321 indicates the professional class.

<Crop Type Information>

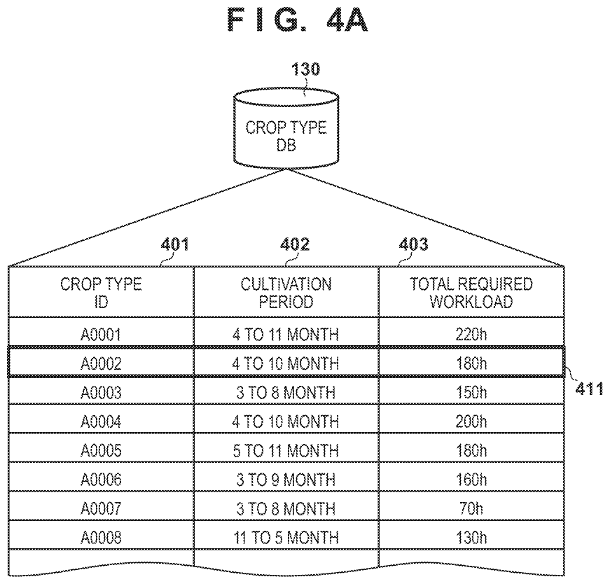

As illustrated in FIG. 4A, for example, the crop type information managed for each work level in the crop type DB 130 is configured such that each record includes a crop type ID 401, a cultivation period 402, and a total required workload 403.

Here, the crop type ID 401 is identification information for uniquely specifying the crop type. In addition, the cultivation period 402 is information indicating a period when the crop type specified by the crop type ID 401 is generally cultivated. In addition, the total required workload 403 indicates a total workload required in a case where the crop type specified by the crop type ID 401 is cultivated in land having a reference area such as 1 tatami mat, for example. Here, the reference area may be commonly determined for all kinds of crop types, or may be the minimum required area for cultivation determined for each crop type. In the proposal system of the present embodiment, the total workload required for the cultivation of each crop type is determined as an average work time required when one agricultural worker belonging to an experienced full-time farmer performs farm work in all processes of the cultivation of the crop type.

Therefore, for example, as the information regarding the cultivation of the crop type “A0002”, from the cultivation period 402 and the total required workload 403 of the record 411 in which the crop type ID 401 indicates A0002 in FIG. 4A, it can be seen that the cultivation period is April to October, and the total required workload is 180 hours.

Note that the proposal service of the present embodiment is intended particularly for a person who newly enters agriculture or a person who has no experience in agriculture, and since such a person rarely owns or uses an agricultural machine or the like, the work time using the agricultural machine or the like is not included in deriving the total required workload 403.

<Hardware Configuration of Communication Terminal 200>

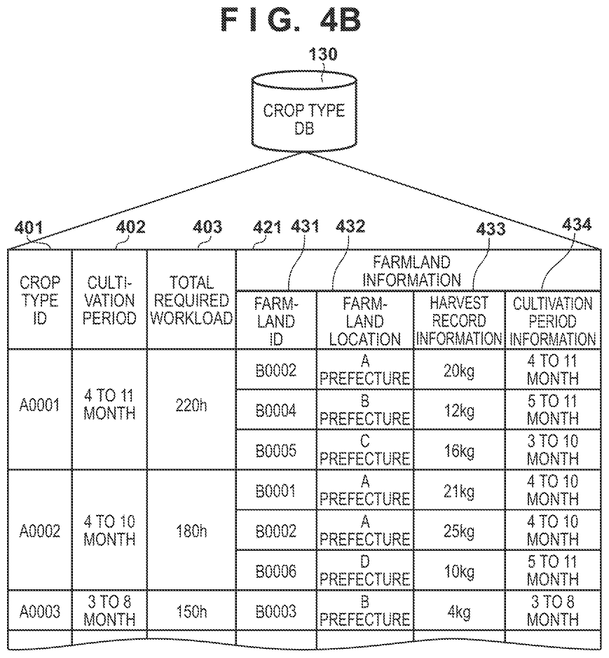

Next, a hardware configuration of the communication terminal 200 of the present embodiment will be described with reference to a block diagram of FIG. 5. The control unit 201 is a processor represented by a CPU, and implements operation control of each block and various functions to be described later by developing a program recorded in the storage device 202 in the memory 203 and executing the program. The storage device 202 is a nonvolatile storage device capable of permanently storing information, such as a ROM or an HDD. The memory 203 is a volatile storage device such as a RAM, and is used not only as a development area of a program or a work area of a function but also as a storage area in which information output by the operation of each block is temporarily recorded. The communication I/F 204 is an interface for performing information communication with an external device, and in the present embodiment, performs information communication with the proposal server 100 via the network 300. The operation I/F 205 is various input devices included in the communication terminal 200. The display device 206 is a display device included in the communication terminal 200 such as an LCD.

The storage device 202 stores a program of a browsing application (hereinafter, simply referred to as a browser) in addition to a program related to the operating system of the communication terminal 200. When the browser is activated in the communication terminal 200 and the user performs an operation input related to an access request to a website related to a proposal service provided by the proposal server 100, the communication terminal 200 is communicably connected to the proposal server 100 and enters a service available state. During the use of the proposal service, various pieces of information related to the proposal service received via the browser are presented using the display device 206.

<<Outline of Proposal Service>>

Hereinafter, an outline of the proposal service provided by the proposal server 100 of the present embodiment will be described.

In providing the proposal service, the proposal server 100 acquires, from the communication terminal 200, physical strength information necessary for evaluating the physical strength of the worker and time information regarding a scheduled time (scheduled farm work time) during which the worker is scheduled to perform farm work. That is, the user can receive the information on the crop type proposed by the proposal server 100 by performing an operation of inputting these pieces of information and transmitting the information to the proposal server 100 together with the proposal request in the communication terminal 200 used by the user.

In the proposal system of the present embodiment, the physical strength evaluation value of the worker is derived based on the age of the worker, the presence or absence of the exercise habit, and the degree thereof. More specifically, the physical strength evaluation value of the worker is derived by adjusting a reference physical strength evaluation value obtained from the physical strength evaluation value 302 of the basic physical strength information according to the age of the worker according to the presence or absence and the degree of the exercise habit of the worker. Here, the adjustment according to the exercise habit is performed according to an adjustment rule in which an exercise ability test uniquely provided in the proposal system is performed on persons in each age group in advance, and according to the result of the exercise ability test, information on how much the reference physical strength evaluation value determined for the age group should be increased or decreased is formulated.

For example, the reference physical strength evaluation value for the worker in his/her twenties is obtained as records 311 to 75 illustrated in FIG. 3A, but when the full marathon is input as the exercise habit of the worker and the record is 3 hours, 47 minutes, and 18 seconds, the physical strength evaluation value of the worker is adjusted to 90. On the contrary, for example, when the worker does not have an exercise habit, the physical strength evaluation value of the worker is adjusted to 55 lower than 75. Note that it will be easily understood that various methods can be adopted for adjustment of the physical strength evaluation value based on the input content of the exercise habit and the input content, and the adjustment is not limited to the example.

When the physical strength evaluation value of the worker is derived, the work level of the worker is specified based on the value. The work level may be specified according to which of the following value ranges the physical strength evaluation value belongs to.
Professional class: 80 to 100
Semi-professional class: 60 to 79
Experienced class: 40 to 59
Layman class: 0 to 39

Therefore, for example, the work level of the worker whose physical strength evaluation value is 90 is specified as the professional class, and the work level of the worker whose physical strength evaluation value is 55 is specified as the experienced class.

Once the work level is specified, the total expected workload of the worker is derived. The total expected workload is derived by multiplying the total work time that the worker can perform by the workload expected in the unit period obtained by the unit period workload 322 of the efficiency information according to the work level (unit is time). In the proposal system of the present embodiment, it is assumed that inputs of a time during which the worker can perform the farm work in one week and a period (for example, April to November, hereinafter, referred to as an engagement period) during which the worker can be engaged in the farm work are received as the time information regarding the scheduled farm work time. Therefore, the total expected workload of the worker can be derived by:

(total expected workload)=(unit period workload)×(work time per week)×(number of weeks).

Here, the number of weeks is a value obtained by converting the engagement period into the number of weeks. That is, the total expected workload of the worker is derived by multiplying the total work time of the worker expected during the engagement period by the average workload per hour of the work level into which the worker is classified.

When the total expected workload of the worker is derived, the crop type that can be cultivated during the engagement period and can be cultivated within the range of the total expected workload is selected as the crop type to be proposed to the user. More specifically, among the crop types of which the crop type information is managed in the crop type DB 130, a crop type in which all the cultivation periods 402 are included in the engagement period and the total required workload 403 does not exceed the total expected workload is selected as the proposed crop type.

The number of proposed crop types may be limited to a predetermined number such as five kinds. In this case, as the proposed crop type, for example, from among the crop types in which all the cultivation periods 402 are included in the engagement period and the total required workload 403 does not exceed the total expected workload, the top five crop types in which the total required workload 403 is large may be selected to extract a part thereof.

The information on the selected crop type is returned to the communication terminal 200 that has made the proposal request, and is displayed on the display device 206 of the communication terminal 200. As a result, the user can grasp the crop type that can be suitably cultivated by the worker who has input the information.

<<Proposal Processing>>

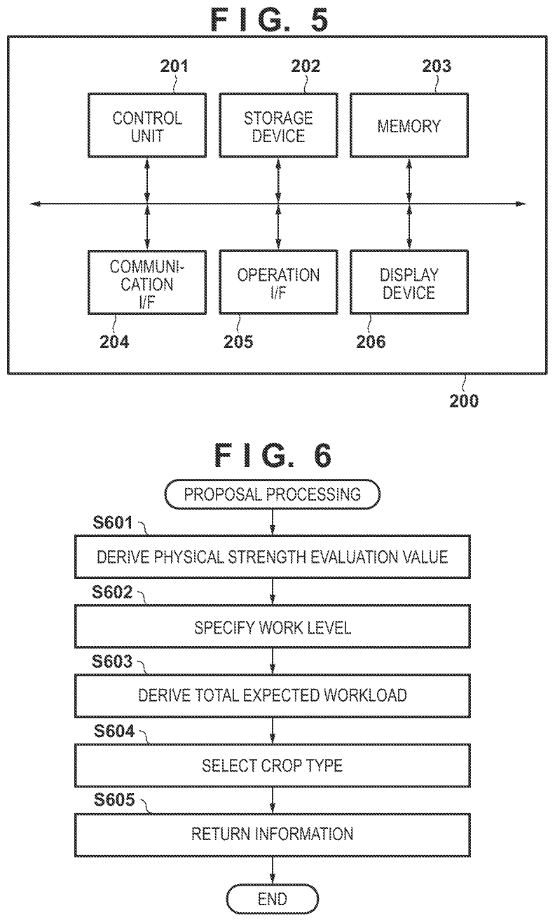

Hereinafter, specific processing of the proposal processing executed according to the selection of the proposed crop type in the proposal server 100 of the present embodiment will be described with reference to the flowchart of FIG. 6. The processing corresponding to the flowchart can be realized by the control unit 101, for example, reading a corresponding processing program recorded in the storage device 102, developing the processing program in the memory 103, and executing the processing program. The present proposal processing will be described as being started when the physical strength information and the time information of the worker are received together with the proposal request of the crop type to be cultivated from the communication terminal 200. In the following description of the proposal processing, a worker to who the user makes a proposal request will be referred to as a “target worker”.

In S601, the control unit 101 derives a physical strength evaluation value of the target worker. More specifically, the control unit 101 reads the physical strength evaluation value 302 of the basic physical strength information corresponding to the age of the target worker as the reference physical strength evaluation value based on the age information included in the received physical strength information. In addition, the control unit 101 derives the physical strength evaluation value of the target worker by adjusting the reference physical strength evaluation value according to the habit information included in the received physical strength information.

In S602, the control unit 101 specifies the work level of the target worker based on the physical strength evaluation value of the target worker derived in S601.

In S603, the control unit 101 derives the total expected workload of the target worker. More specifically, the control unit 101 multiplies the unit period workload 322 of the efficiency information corresponding to the work level of the target worker specified in S602 by the total work time based on the received time information, thereby deriving the total expected workload of the target worker.

In S604, the control unit 101 selects a proposed crop type. More specifically, the control unit 101 first extracts crop types in which all the cultivation periods 402 are included in the engagement period included in the received time information among the crop types of which the crop type information is managed in the crop type DB 130. Then, the control unit 101 further extracts a crop type in which the total required workload 403 does not exceed the total expected workload derived in S603 from among the extracted crop types, and selects the crop type as a crop type to be proposed to the user who has made the proposal request.

In S605, the control unit 101 transmits the information on the crop type selected in S604 to the communication I/F 104, returns the information to the communication terminal 200 that has made the proposal request, and completes the proposal processing.

By doing so, according to the information processing apparatus of the present embodiment, it is possible to propose a crop type suitable for cultivation to a work group that performs farm work according to the characteristics of the worker of the work group, and eventually support sustainable agriculture. More specifically, it is possible to propose a crop type that can be cultivated in the scheduled farm work time of the worker after evaluating the work ability of the worker in consideration of the physical strength of the worker, and thus it is possible to propose a suitable crop type that can be harvested even by a person who newly enters agriculture or a person who has no experience in agriculture.

In the present embodiment, it has been described that the work group in which the user makes the proposal request includes only one worker, but the implementation of the present invention is not limited thereto. That is, the present invention is also applicable to a work group including a plurality of workers. In this case, the control unit 101 may derive the total expected workload of the work group as follows, for example.

The control unit 101 derives the physical strength evaluation value for each of the workers belonging to the work group based on the physical strength information of the worker, and averages the physical strength evaluation values to derive the physical strength evaluation value of the entire work group. Subsequently, the control unit 101 specifies the work level of the work group similarly to the case of one worker using the physical strength evaluation value of the entire work group. Then, the control unit 101 multiplies the total work time based on the time information received for the work group by the workload expected in the unit period corresponding to the specified work level to derive the total expected workload of the work group.

At this time, when the time information defines the scheduled farm work time during which the farm work is performed for the entire work group (work group works 2 hours per week from April to November, etc.), the control unit 101 may derive the total work time by multiplying this by the number of workers belonging to the work group. When the time information defines the scheduled farm work time during which the farm work is performed for each worker belonging to the work group (for example, the worker A in the work group works two hours a week from April to October), the control unit 101 may derive the total work time by summing them.

In addition, in the present embodiment, it has been described that the total expected workload is derived by simply multiplying the total work time of the worker by the workload expected in the unit period of the worker, and the proposed crop type is selected based on the total workload and the total required workload of each crop type, but the implementation of the present invention is not limited thereto. Since the cultivation period varies depending on the crop type, and the cultivation period for which the total required workload is to be obtained varies, when selecting the crop type, the control unit 101 may change the total expected workload by changing the engagement period for each crop type for which the total workload is to be compared.

More specifically, when determining whether an arbitrary crop type can be cultivated under the condition of the worker, the control unit 101 derives the total expected workload by multiplying the number of hours during which the worker engages in the farm work in the period indicated by the cultivation period 402 of the crop type information related to the crop type by the expected workload of the worker in the unit period. For example, even in a case where it is determined that the worker works for 2 hours per week from April to November as the time information of the worker, in a case where the cultivation period of the crop type to be determined is from April to October, the engagement period during which the worker actually performs farm work is from April to October. Therefore, the number of hours during which the worker is engaged in farm work in this period is 2 hours×31 weeks (the number of weeks from April to October)=62 hours. Then, the control unit 101 may determine whether the worker can cultivate the crop type by comparing the derived total expected workload with the total required workload 403 of the same crop type information.

In addition, in the present embodiment, it has been described that the total expected workload is derived on the assumption that the worker of the work group manually performs the farm work, but the implementation of the present invention is not limited thereto. That is, the farm work performed by the worker need not be limited to manual works, and may be performed by using work tools (body assisting devices such as power assisting suits, haulage vehicles, agricultural implements such as hoes and spades, and agricultural machines such as tractors and walking cultivators) available to the worker when the work tools are available.

In a case where the farm work is performed using the work tool in this manner, the workload of the worker is naturally larger than that in a case where the entire work is performed manually. Therefore, by further inputting information on the work tool available to the worker, the correction unit period workload corrected by multiplying the unit period workload of the work group by the correction coefficient based on the information may be used when deriving the total expected workload.

In addition, a work tool used for farm work for cultivation and a degree of reducing the workload by the use are different depending on each crop type. Therefore, it is assumed that the information on the correction coefficient related to each work tool is determined and managed for each crop type in the work tool DB (not illustrated). When deriving the total expected workload of the worker, the control unit 101 refers to the corresponding information in the work tool DB for each crop type for which the total expected workload is compared, and may derive the total expected workload using, for example, a correction coefficient obtained by summing (for example, when a walking cultivator and a plow are used, the correction coefficients of these work tools defined for the corresponding crop type are summed up) correction coefficients determined for the work tool planned to be used by the worker.

### Second Embodiment

In the embodiment described above, the aspect in which the information on the crop type selected based on the physical strength information and the time information of the worker is presented to the communication terminal 200 of the user who has made the proposal request has been described, but the implementation of the present invention is not limited thereto. For example, a person who intends to newly enter agriculture does not necessarily secure farmland (owned or leased land). In addition, since there are soil and climate suitable for cultivation depending on the crop type, even if the user selects one of the crop types proposed in the proposal service and cultivates the crop type in the farmland secured by the user, there is a possibility that good harvest cannot be obtained. In the present embodiment, a proposal service further including a function of proposing a farmland suitable for the cultivation of a crop type to a user who has not secured a farmland as described above will be described.

<<Farmland Information>>

The proposal server 100 of the present embodiment is different in that the crop type information managed in the crop type DB 130 further includes the farmland information 421 as illustrated in FIG. 4B. The farmland information 421 indicates information regarding the farmland in which the crop type has been cultivated in the past for the crop type indicated by the crop type ID 401 of the crop type information related to one record. Here, the farmland information 421 includes a farmland ID 431, a farmland location 432, harvest record information 433, and cultivation period information 434 for each of the farmlands in which the crop type is cultivated.

The farmland ID 431 is identification information that uniquely specifies the farmland. Furthermore, the farmland location 432 is information indicating the location of the farmland specified by the farmland ID 431. The farmland location 432 may be, for example, information indicating an area where a farmland exists, such as a municipality or a prefecture. In addition, the harvest record information 433 is information on the harvest record of the corresponding crop type in the farmland specified by the farmland ID 431. The harvest record information 433 may indicate, for example, a harvest amount per unit area of the corresponding crop type in the farmland in the past year. Furthermore, the cultivation period information 434 is information indicating the period when the corresponding crop type is cultivated in the farmland specified by the farmland ID 431. The cultivation period information 434 is different from the cultivation period 402 indicating the period when the corresponding crop type is generally cultivated, and indicates the cultivation period recommended in, for example, the area, longitude, and latitude of the farmland, which is determined unique to the farmland.

<<Outline of Proposal Service>>

Next, an outline of a proposal service provided by the proposal server 100 of the present embodiment will be described. In the description of the function of the service, the process described in the first embodiment is omitted.

When the information on the crop type selected based on the total expected workload of the worker is transmitted to the communication terminal 200 and proposed, the user selects a crop type (planned crop type) to be cultivated from among the proposed crop type. When the planned crop type is selected, a farmland proposal request including the crop type ID of the crop type is transmitted from the communication terminal 200 to the proposal server 100.

When the farmland proposal request is received, the area of the farmland suitable for the cultivation of the planned crop type is selected in the proposal server 100. Then, the information on the selected farmland area is transmitted to the communication terminal 200 as information on the farmland area recommended to be secured, and is displayed on the display device 206. Here, in the present embodiment, the farmland area suitable for the cultivation of the planned crop type is selectable in two types, a harvest amount basis and a cultivation period basis. Note that which base is used to select a farmland area suitable for cultivation is changeable according to an operation input related to the selection made in the communication terminal 200.

First, the farmland area suitable for cultivation on a harvest amount basis is selected based on the farmland location 432 of the information on a predetermined number of top farmlands in a case where the harvest record information 433 is arranged in descending order among the information on each farmland included in the farmland information 421 of the crop type information managed in the crop type DB 130 according to the planned crop type. This is because it is estimated that the area where the harvest amount of the planned crop type is high is an area where soil and climate conditions suitable for the cultivation of the crop type are satisfied. Therefore, in the aspect of extracting the candidates of the farmland area on the harvest amount basis, the user is proposed of an area having soil in which a good harvest amount can be expected for the planned crop type, and the user can select the farmland to be secured from the area.

On the other hand, the farmland area suitable for cultivation on the cultivation period basis is selected based on the farmland location 432 of the information on the predetermined number of top farmlands in which the cultivation period information 434 matches the engagement period indicated by the time information of the worker (for example, the work start timing is close to the start timing of the engagement period scheduled by the worker, and the entire period is close to the length of the engagement period) among the information on each farmland included in the farmland information 421 of the crop type information managed in the crop type DB 130 according to the planned crop type. This is because, depending on the area of the farmland, the period required for cultivation may vary depending on weather conditions or the like. Therefore, in the aspect of extracting the candidates of the farmland area on the cultivation period basis, an area that matches the scheduled farm work time or the work pace of the worker is proposed to the user, and the user can select the farmland to be secured from the proposed areas.

<<Proposal Processing>>

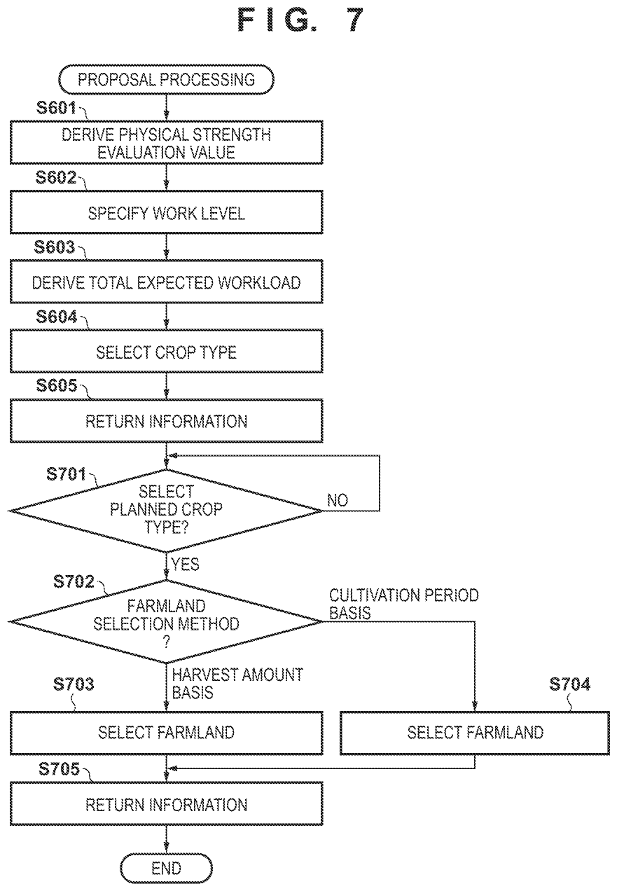

Hereinafter, specific processing of the proposal processing executed according to the selection of the proposed crop type in the proposal server 100 of the present embodiment will be described with reference to the flowchart of FIG. 7. The processing corresponding to the flowchart can be realized by the control unit 101, for example, reading a corresponding processing program recorded in the storage device 102, developing the processing program in the memory 103, and executing the processing program. Note that, in the proposal processing of the present embodiment, steps of performing the same processing as the proposal processing of the first embodiment are denoted by the same reference numerals and description thereof is omitted, and only steps of performing processing unique to the present embodiment will be described below.

When the information on the crop type proposed in S605 is returned to the communication terminal 200, the control unit 101 determines whether a planned crop type has been selected from the crop types in S701. The determination in this step is performed according to whether the farmland proposal request transmitted to the proposal server 100 is received in response to the operation input related to the selection of the planned crop type in the communication terminal 200. When the control unit 101 determines that the planned crop type has been selected, the processing proceeds to S702, and when the control unit determines that the planned crop type has not been selected, the processing of this step is repeated.

In S702, the control unit 101 determines whether to select the proposed farmland area on the harvest amount basis or the cultivation period basis. The determination in this step may be made according to, for example, information on the selection status of the selection method in the communication terminal 200. In a case where the control unit 101 determines that the proposed method for selecting the farmland area is the harvest amount basis, the processing proceeds to S703, and in a case where the method is the cultivation period basis, the processing proceeds to S704.

In S703, the control unit 101 selects the proposed farmland based on the harvest amount of the planned crop type. More specifically, the control unit 101 sorts the information on the farmland included in the farmland information 421 of the crop type information corresponding to the planned crop type in descending order of the harvest record information 433, and selects the farmland area indicated by the farmland location 432 of the information on the predetermined number of top farmlands as the proposed farmland area.

On the other hand, in a case where it is determined in S702 that the method for selecting a farmland area proposed is the cultivation period basis, the control unit 101 selects the farmland area proposed based on the cultivation period of the planned crop type in S704. More specifically, the control unit 101 specifies, from the information on the farmland included in the farmland information 421 of the crop type information corresponding to the planned crop type, the information of a predetermined number of top farmlands having a high degree of similarity between the period indicated by the cultivation period information 434 and the engagement period based on the received time information, and selects the farmland area indicated by the farmland location 432 of the information as the proposed farmland area.

In S705, the control unit 101 transmits the information on the selected farmland to the communication I/F 104, returns the information to the communication terminal 200 that has made the farmland proposal request, and completes the proposal processing.

In this way, when the user selects the planned crop type to be cultivated from among the crop types proposed based on the physical strength and the scheduled farm work time of the worker, the user can further receive a proposal of the farmland suitable for the cultivation of the planned crop type or the farmland matching the plan of the scheduled farm work time of the user.

### First Modification

In the second embodiment described above, the description has been given assuming that the cultivation period information 434 set in consideration of the weather conditions peculiar to the area is referred to when proposing the farmland suitable for cultivation on the cultivation period basis. On the other hand, the regional and national weather trends can change year by year, and the cultivation period indicated by the cultivation period information 434 set based on the information of the past year and the like may deviate from the cultivation period of the corresponding crop in the future. Therefore, in the proposal system, for example, as illustrated in FIG. 1B, the proposal server 100 may be configured to be further communicably connectable to an external prediction server 310 that performs weather prediction.

In the present aspect, when selecting a proposed farmland area, the control unit 101 can acquire weather information regarding future (for example, the year in which cultivation is proposed) weather prediction from the prediction server 310. The weather information may include various kinds of information such as rainfall, sunshine hours, or occurrence probability of a typhoon or flood damage in each area, for example, in a year in which cultivation is proposed (hereinafter, it is referred to as a proposed year). For example, the control unit 101 may specify information on the farmland in which cultivation can be performed under weather conditions similar to those of the past year in the proposal year among the farmland information included in the farmland information 421 of the crop type information corresponding to the crop type corresponding to the planned crop type, and select the farmland area indicated by the farmland location 432 of the information as the proposed farmland area.

### Second Modification

In the second embodiment and the first modification described above, an aspect in which a farmland area to be proposed to the user is selected based on the harvest record information 433 included in the farmland information 421 of the crop type selection, the cultivation period information 434, or the weather information acquired from the prediction server 310 has been described, but the implementation of the present invention is not limited thereto. By using these pieces of information in combination, a more suitable farmland area can be proposed to the user.

For example, the control unit 101 may correct the cultivation period indicated by the cultivation period information 434 to the proposed year based on the weather information, and select the proposed farmland area based on the similarity between the corrected cultivation period and the engagement period of the worker. Alternatively, for example, the control unit 101 may correct the harvest amount of each farmland indicated by the harvest record information 433 for the proposed year based on the weather information, and select the farmland area to be proposed based on the corrected harvest amount. In addition, for example, the control unit 101 may combine these pieces of information after the correction, and may select a farmland area in which the cultivation of the planned crop type can be performed in the cultivation period close to the engagement period of the worker and the expected harvest amount in the proposed year is high.

That is, the proposed farmland area may be selected based on at least one of the harvest record information of the planned crop type, the cultivation period information on the crop type, and the weather information.

### Third Modification

Meanwhile, in the first embodiment described above, it has been described that the total required workload 403 of the crop type information is a total workload required in a case where cultivation is performed on land having a reference area such as 1 tatami mat. On the other hand, in a case where there is a plurality of workers belonging to the work group, or in a case where a crop type having a total workload smaller than the total expected workload is selected as the planned crop type, it is assumed that there is a surplus in the workload that can be handled by the work group. In such a case, based on the information on the selected planned crop type and the total expected workload of the work group, the information on the area that can be handled by the work group may be presented together with the information of the proposed farmland.

For example, in a case where the work group in which the total expected workload is 500 hours selects the crop type in which the total workload related to the reference area (1 tatami mat) is 250 hours as the planned crop type, the workload for 250 hours is surplus. Therefore, two tatami mats obtained by multiplying the reference area of one tatami mat by 500/250=2 are derived as the maximum value of the farmland area that can be handled by the work group. Therefore, in a case where the communication terminal 200 proposes a farmland area, information on both the minimum area and the maximum area is presented as the farmland area that can be handled by the work group in each area.

### Fourth Modification

In the second embodiment and the first to third modifications described above, an aspect has been described in which a farmland suitable for the cultivation of a selected planned crop type is proposed for a user who has not secured a farmland, but the implementation of the present invention is not limited thereto. For example, the proposal of the farmland is unnecessary for the user who has already secured the farmland or the user who has determined the area of the farmland to be secured. In addition, if a farmland area has been determined, a more suitable crop type can be proposed by referring to harvest record, cultivation period, and weather information in the area. Therefore, in the present modification, a proposal service that enables the worker to input information on the farmland where the worker is planned to perform the farm work when proposing the crop type will be described.

<<Proposal Processing>>

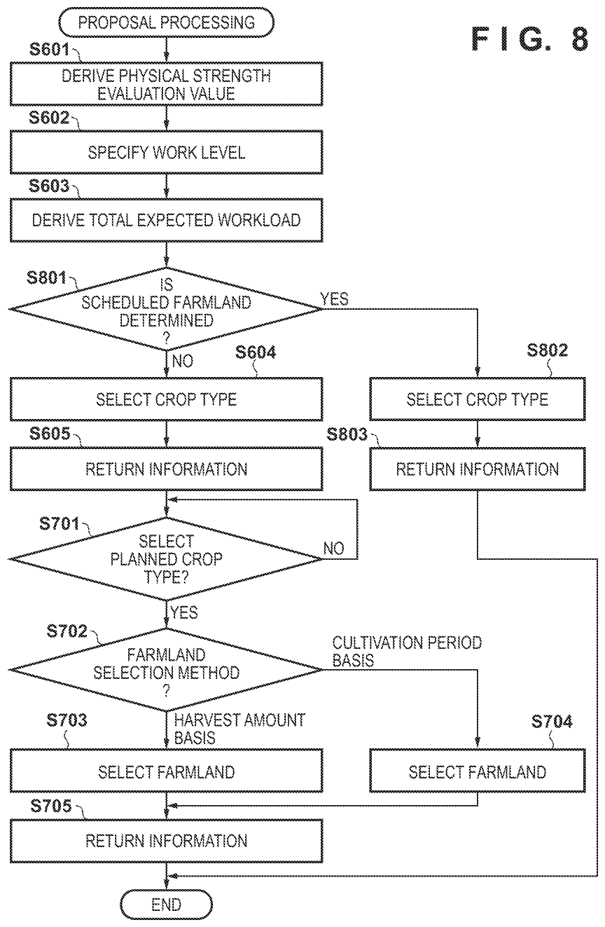

Hereinafter, the proposal processing executed according to the selection of the proposed crop type in the proposal server 100 of the present modification will be described in detail with reference to the flowchart of FIG. 8. The processing corresponding to the flowchart can be realized by the control unit 101, for example, reading a corresponding processing program recorded in the storage device 102, developing the processing program in the memory 103, and executing the processing program. Note that, in the proposal processing of the present modification, steps of performing the same processing as the proposal processing of the first or second embodiment are denoted by the same reference numerals and description thereof is omitted, and only steps of performing processing unique to the present modification will be described below. In addition, the crop type information will be described assuming that it has the configuration illustrated using FIG. 4B in the second embodiment. In addition, in the following description, in order to facilitate understanding of the invention, in a case where a farmland area where the target worker is planned to perform farm work is determined, it is assumed that the planned farmland information indicating the farmland area is received together with the proposal request for the crop type to be cultivated.

When deriving the total expected workload of the target worker in S603, the control unit 101 determines whether the farmland area where the target worker is planned to perform the farm work is determined in S801. The determination in this step may be performed, for example, according to whether the planned farmland information has been received together with the proposal request of the crop type. In a case where the control unit 101 determines that the farmland area where the target worker is planned to perform the farm work has been determined, the processing proceeds to S802, and in a case where it is determined that the farmland area has not been determined, the processing proceeds to S604.

In S802, the control unit 101 selects a proposed crop type. More specifically, the control unit 101 first extracts crop types in which all the cultivation periods 402 are included in the engagement period included in the received time information among the crop types of which the crop type information is managed in the crop type DB 130. Then, the control unit 101 further extracts, from among the extracted crop types, a crop type in which the total required workload 403 does not exceed the total expected workload derived in S603. Furthermore, the control unit 101 further extracts a crop type in which the information on the farmland indicated by the farmland location 432 is included in the farmland information 421, from among the extracted crop types, and selects an area corresponding to the area indicated by the received planned farmland information, as a crop type to be proposed to the user who has made the proposal request. In this way, the crop type in which the cultivation period is included in the engagement period, the total required workload does not exceed the total expected workload, and there is the cultivation record in the farmland area where the target worker is planned to perform the farm work is selected as the proposed crop type.

In S803, the control unit 101 transmits the information on the crop type selected in S802 to the communication I/F 104, returns the information to the communication terminal 200 that has made the proposal request, and completes the proposal processing.

In this way, it is possible to propose an appropriate cultivatable crop type according to the farmland to the user who secures the farmland or the user who determines the farmland area.

### Fifth Modification

In the embodiments and the modifications described above, the aspect has been described in which the information of the total required workload 403 of the work type information is determined as an average work time required when one agricultural worker belonging to an experienced full-time farmer performs farm work in all processes, and the proposed crop type is selected based on the average work time and the total expected workload derived based on the workload per unit period according to the work level of the worker. However, in the embodiment described above, depending on the age and the exercise habit of the worker, the worker is classified into the work level (professional class) at which the worker can perform the same workload as the agricultural worker belonging to the experienced full-time farmer in terms of physical strength, and thus, for example, a person who newly enters the agriculture may be treated as being able to perform each step of cultivation in the same time as the agricultural worker belonging to the experienced full-time farmer. In other words, although there is a difference in cultivation experience between a person who newly enters agriculture and an agricultural worker belonging to an experienced full-time farmer, depending on the work level at which the worker is classified, there is a possibility that a crop type that is difficult to cultivate within the scheduled farm work time is actually proposed.

Therefore, for example, in setting the total required workload 403 related to each crop type, a value obtained by multiplying the average work time of the agricultural worker belonging to the experienced full-time farmer by a coefficient (1.25, 1.5, or the like) corresponding to a difference in cultivation experience may be used.

### Sixth Modification

In the embodiments and the modifications described above, it has been described that the database of various types of information exists in the storage device 102 of the proposal server 100, but the implementation of the present invention is not limited thereto. Some or all of the databases may be provided in a device outside the proposal server 100, and the proposal server 100 may be configured to acquire information from the corresponding device as necessary.

### Third Embodiment

In the above-described embodiments, it has been described that the proposal server 100 executes the proposal processing, but the proposal processing may be executed, for example, in an information communication terminal used by an operator of an event for new agricultural entrants in an event venue or the like. Then, the operator or the event staff may check the information on the crop type proposed by inputting the physical strength information, the time information, and the like of the consultation person to a person (consultation person) who visits the consultation on the crop type at the event venue, and transmit the information to the consultation person. In this case, a CPU (not illustrated) incorporated in the information communication terminal develops a program of selection processing recorded in a storage device such as an HDD into a RAM or the like, thereby executing the proposal processing. Here, the program of the proposal processing executed by the CPU may be installed in a storage device of the information communication terminal via a storage medium such as a CD-ROM.

Although the present invention has been described in a plurality of embodiments and modifications, the configurations of these embodiments and modifications may be applied in combination.

### Summary of Embodiments

The above-described embodiments disclose at least the following information processing apparatus, information processing method, and storage medium.

1. The information processing apparatus of the above embodiments comprises:
an acquisition unit configured to acquire physical strength information related to physical strength and time information related to a scheduled farm work time of a work group including at least one worker who performs farm work;
a determination unit (S601, S602) configured to determine a work ability of the work group based on the physical strength information; and
a crop type selection unit (S603, S604, S802) configured to select a crop type to be proposed to the work group based on the work ability determined by the determination unit and the time information acquired by the acquisition unit.

According to this embodiment, it is possible to propose a crop type suitable for the work group based on the physical strength of the worker and the scheduled farm work time of the work group.

2. The information processing apparatus of the above embodiments, wherein
the work ability is a workload of a farm work performed in a unit period by the work group,
the determination unit (S602) executes:
   specifying a work level corresponding to the work group among a plurality of types of work levels based on the physical strength information; and
   determining a workload per unit period of the work group based on efficiency information defining a workload per unit period for each work level and a work level of the work group, and
the crop type selection unit (S603, S604, S802) selects the proposed crop type based on the workload per unit period of the work group and the time information.

According to this embodiment, it is possible to estimate the workload expected for the work group and propose a crop type suitable for the work group based on the workload.

3. The information processing apparatus of the above embodiments, wherein
the crop type selection unit (S603, S604, S802) executes:
   deriving a total expected workload of the work group based on the workload per unit period of the work group and the time information; and
   selecting the proposed crop type based on reference information defining a total workload for each crop type and the derived total expected workload.

According to this embodiment, it is possible to propose a crop type that requires a workload that matches the total expected workload expected for the work group.

4. The information processing apparatus of the above embodiments, wherein
the physical strength information includes age information related to age and habit information related to an exercise habit of the worker included in the work group, and
the determination unit (S601, S602) executes:
   deriving a physical strength evaluation value of each worker in the work group by correcting a physical strength evaluation value determined based on basic physical strength information defining a physical strength evaluation value for each age group and the age information based on the habit information; and
   specifying the work level of the work group based on the physical strength evaluation value derived for the at least one worker included in the work group.

According to this embodiment, it is possible to estimate the work ability according to the exercise ability of the worker and propose the crop type that can be cultivated with the work ability.

5. The information processing apparatus of the above embodiments, wherein
the time information includes period information related to a period when the work group performs farm work, and
the crop type selection unit (S604, S802) selects, as the proposed crop type, a crop type in which a period at which farm work is to be performed is included in a period indicated by the period information.

According to this embodiment, it is possible to propose a crop type that can be cultivated in a period in which the work group is planned to perform farm work.

6. The information processing apparatus of the above embodiments, further comprises:
a designation unit (S701) configured to receive designation of a crop type to be cultivated by the work group among the crop type selected by the crop type selection unit; and
a farmland selection unit (S703, S704) configured to select a farmland to be proposed to the work group based on farmland information indicating a farmland that can be cultivated for each crop type and a crop type to be cultivated by the work group for which designation has been received by the designation unit.

According to this embodiment, it is possible to propose a farmland suitable for the cultivation of the crop type for the work group in which the farmland is not secured.

7. The information processing apparatus of the above embodiments, wherein
the farmland information includes harvest record information regarding a harvest record for each crop type, and
the farmland selection unit (S703) selects the proposed farmland based on the harvest record information on the crop type cultivated by the work group.

According to this embodiment, it is possible to propose a farmland having a harvest record for the crop type to be cultivated.

8. The information processing apparatus of the above embodiments, wherein
the time information includes period information related to a period when the work group performs farm work,
the farmland information includes cultivation period information related to a cultivation period of each crop type, and
the farmland selection unit (S704) further selects the proposed farmland based on the period information and the cultivation period information on the crop type cultivated by the work group.

According to this embodiment, it is possible to propose a farmland in which the cultivation period of the crop type to be cultivated corresponds to the period when the farm work of the work group is performed.

9. The information processing apparatus according to claim 6, wherein
the acquisition unit further acquires weather information related to weather prediction, and
the farmland selection unit further selects the proposed farmland based on the weather information.

According to this embodiment, it is possible to propose a farmland suitable for the work group to cultivate the crop type in consideration of the weather prediction.

10. The information processing apparatus of the above embodiments, wherein
the acquisition unit further acquires weather information related to weather prediction,
the time information includes period information related to a period when the work group performs farm work,
the farmland information includes harvest record information related to a harvest record for each crop type and cultivation period information related to a cultivation period for each crop type, and
the farmland selection unit selects the proposed farmland based on at least one of the harvest record information on the crop type cultivated by the work group, the cultivation period information on the crop type, and the weather information.

According to this embodiment, it is possible to propose a farmland more suitable for the cultivation of a crop type.

11. The information processing apparatus of the above embodiments, wherein
the acquisition unit further acquires farmland information indicating a farmland in which the work group performs farm work, and
the crop type selection unit (S802) further selects the proposed crop type based on the farmland information when the farmland information is acquired.

According to this embodiment, it is possible to propose a crop type that can be suitably cultivated in a farmland for a work group that has considered the farmland.

12. The information processing method of the above embodiments comprises:
acquiring physical strength information related to physical strength and time information related to a scheduled farm work time of a work group including at least one worker who performs farm work;
determining (S601, S602) a work ability of the work group based on the physical strength information; and
selecting (S603, S604, S802) a crop type to be proposed to the work group based on the determined work ability and the acquired time information.

According to this embodiment, it is possible to propose a crop type suitable for the work group based on the physical strength of the worker and the scheduled farm work time of the work group.

13. The non-transitory computer-readable storage medium of the above embodiments stores therein a program for causing a computer to execute:
an acquisition process of acquiring physical strength information related to physical strength and time information related to a scheduled farm work time of a work group including at least one worker who performs farm work;
a determination process (S601, S602) of determining a work ability of the work group based on the physical strength information; and
a crop type selection process (S603, S604, S802) of selecting a crop type to be proposed to the work group based on the work ability determined in the determination process and the time information acquired in the acquisition process.

According to this embodiment, it is possible to propose a crop type suitable for the work group based on the physical strength of the worker and the scheduled farm work time of the work group.

The invention is not limited to the foregoing embodiments, and various variations/changes are possible within the spirit of the invention.

What is claimed is:

1. An information processing apparatus comprising:
an acquisition unit configured to acquire physical strength information related to physical strength and time information related to a scheduled farm work time of a work group including at least one worker who performs farm work;
a determination unit configured to determine a work ability of the work group based on the physical strength information; and
a crop type selection unit configured to select a crop type to be proposed to the work group based on the work ability determined by the determination unit and the time information acquired by the acquisition unit.

2. The information processing apparatus according to claim 1, wherein
the work ability is a workload of a farm work performed in a unit period by the work group,
the determination unit executes:
specifying a work level corresponding to the work group among a plurality of types of work levels based on the physical strength information; and
determining a workload per unit period of the work group based on efficiency information defining a workload per unit period for each work level and a work level of the work group, and
the crop type selection unit selects the proposed crop type based on the workload per unit period of the work group and the time information.

3. The information processing apparatus according to claim 2, wherein
the crop type selection unit executes:
deriving a total expected workload of the work group based on the workload per unit period of the work group and the time information; and
selecting the proposed crop type based on reference information defining a total workload for each crop type and the derived total expected workload.

4. The information processing apparatus according to claim 2, wherein
the physical strength information includes age information related to age and habit information related to an exercise habit of the worker included in the work group, and
the determination unit executes:
deriving a physical strength evaluation value of each worker in the work group by correcting a physical strength evaluation value determined based on basic physical strength information defining a physical strength evaluation value for each age group and the age information based on the habit information; and
specifying the work level of the work group based on the physical strength evaluation value derived for the at least one worker included in the work group.

5. The information processing apparatus according to claim 1, wherein
the time information includes period information related to a period when the work group performs farm work, and
the crop type selection unit selects, as the proposed crop type, a crop type in which a period at which farm work is to be performed is included in a period indicated by the period information.

6. The information processing apparatus according to claim 1, further comprising:
a designation unit configured to receive designation of a crop type to be cultivated by the work group among the crop type selected by the crop type selection unit; and
a farmland selection unit configured to select a farmland to be proposed to the work group based on farmland information indicating a farmland that can be cultivated for each crop type and a crop type to be cultivated by the work group for which designation has been received by the designation unit.

7. The information processing apparatus according to claim 6, wherein
the farmland information includes harvest record information regarding a harvest record for each crop type, and
the farmland selection unit selects the proposed farmland based on the harvest record information on the crop type cultivated by the work group.

8. The information processing apparatus according to claim 6, wherein
the time information includes period information related to a period when the work group performs farm work,
the farmland information includes cultivation period information related to a cultivation period of each crop type, and
the farmland selection unit further selects the proposed farmland based on the period information and the cultivation period information on the crop type cultivated by the work group.

9. The information processing apparatus according to claim 6, wherein
the acquisition unit further acquires weather information related to weather prediction, and
the farmland selection unit further selects the proposed farmland based on the weather information.

10. The information processing apparatus according to claim 6, wherein
the acquisition unit further acquires weather information related to weather prediction,
the time information includes period information related to a period when the work group performs farm work,
the farmland information includes harvest record information related to a harvest record for each crop type and cultivation period information related to a cultivation period for each crop type, and
the farmland selection unit selects the proposed farmland based on at least one of the harvest record information on the crop type cultivated by the work group, the cultivation period information on the crop type, and the weather information.

11. The information processing apparatus according to claim 1, wherein
the acquisition unit further acquires farmland information indicating a farmland in which the work group performs farm work, and
the crop type selection unit further selects the proposed crop type based on the farmland information when the farmland information is acquired.

12. An information processing method comprising:
acquiring physical strength information related to physical strength and time information related to a scheduled farm work time of a work group including at least one worker who performs farm work;
determining a work ability of the work group based on the physical strength information; and
selecting a crop type to be proposed to the work group based on the determined work ability and the acquired time information.

13. A non-transitory computer-readable storage medium storing therein a program for causing a computer to execute:
an acquisition process of acquiring physical strength information related to physical strength and time information related to a scheduled farm work time of a work group including at least one worker who performs farm work;
a determination process of determining a work ability of the work group based on the physical strength information; and
a crop type selection process of selecting a crop type to be proposed to the work group based on the work ability determined in the determination process and the time information acquired in the acquisition process.
